(19) United States
(12) Patent Application Publication
(10) Pub. No.: US 2018/0258697 A1
(43) Pub. Date: Sep. 13, 2018

(54) SAFETY ASSEMBLY FOR LADDERS

(71) Applicant: MILTON R. TORIN, CULVER CITY, CA (US)

(72) Inventor: MILTON R. TORIN, CULVER CITY, CA (US)

(21) Appl. No.: 15/914,632

(22) Filed: Mar. 7, 2018

Related U.S. Application Data
(60) Provisional application No. 62/469,498, filed on Mar. 9, 2017.

(51) Int. Cl. E06C 7/18

(52) U.S. Cl. CPC E06C 7/182; E06C 1/06

(57) ABSTRACT

A safety assembly for ladders includes a pair of angled guide rails and a pair of hollow mounting brackets. Each mounting bracket is configured to receive an end of an angled guide rail. Each guide rail has a first section and a second section connected to the first section. The first and second sections are joined at an angle ranging from about 155 degrees to about 168 degrees. The second section has a length less than a length of the first section.

### CROSS-REFERENCE TO RELATED APPLICATION

This application claims the benefit of U.S. Provisional Patent Application Ser. No. 62/469,498, filed Mar. 9, 2017.

### BACKGROUND OF THE INVENTION

### 1. Field of the Invention

The present invention relates to safety assemblies for ladders, and particularly to a safety assembly that can be connected to a ladder to assist users in safely stepping off or onto a roof.

### 2. Description of the Related Art

While the process of climbing a conventional portable ladder involves some risk, the process of stepping off of the ladder onto a roof or off of a roof onto the ladder is particularly dangerous. Accidents involving ladders generally cause serious injury, and often result in death or paralysis.

Extension rails that are mountable to a top portion of ladder side rails have been previously proposed to assist a user in stepping off or onto a rooftop. Conventional extension rails, however, typically extend collinearly with the side rails of the ladder. As such, once a ladder is positioned to lean against a structure, a user is required to lean forward to reach for the extension rails. This process of leaning forward can be difficult or even dangerous for a user. Other extension rails are adjustable in terms of the angle which they extend from the side rails. The adjustment mechanisms are prone to slip, particularly if they are not properly tightened, thereby creating an unsafe situation. As such, there is still a need in the ladder art for a stable, easy-to-use, and ergonomic guide rail system. Thus, a safety device for ladders solving the aforementioned problems is desired.

### SUMMARY OF THE INVENTION

A safety assembly for ladders includes a pair of hollow mounting brackets and a pair of angled guide rails configured for detachable connection to the mounting brackets. The mounting brackets can be connected to respective side rails of a ladder. Each mounting bracket serves as a socket for one of the guide rails. The angled guide rails each include a first section and a second shorter section wherein the first section extends away from the second section at an angle β. Angle β ranges from about 155 degrees to about 168 degrees. Each guide rail can be attached to a respective mounting bracket in one of three configurations, depending on the position of the ladder relative to the roof and/or the type of roof.

These and other features of the present invention will become readily apparent upon further review of the following specification and drawings.

### BRIEF DESCRIPTION OF THE DRAWINGS

FIG. 1 is an environmental, perspective view of a safety assembly for ladders according to the present invention.

FIG. 2A is a perspective view of a first configuration of the safety assembly for ladders according to the present invention.

FIG. 2B is a perspective view of a second configuration of the safety assembly for ladders according to the present invention.

FIG. 2C is a perspective view of a third configuration of the safety assembly for ladders according to the present invention.

FIG. 3 is an exploded view of the safety assembly for ladders shown in FIG. 1.

FIG. 4 is a detailed sectional view of a mounted portion of the safety assembly for ladders shown in FIG. 1.

Similar reference characters denote corresponding features consistently throughout the attached drawings.

### DETAILED DESCRIPTION OF THE PREFERRED EMBODIMENTS

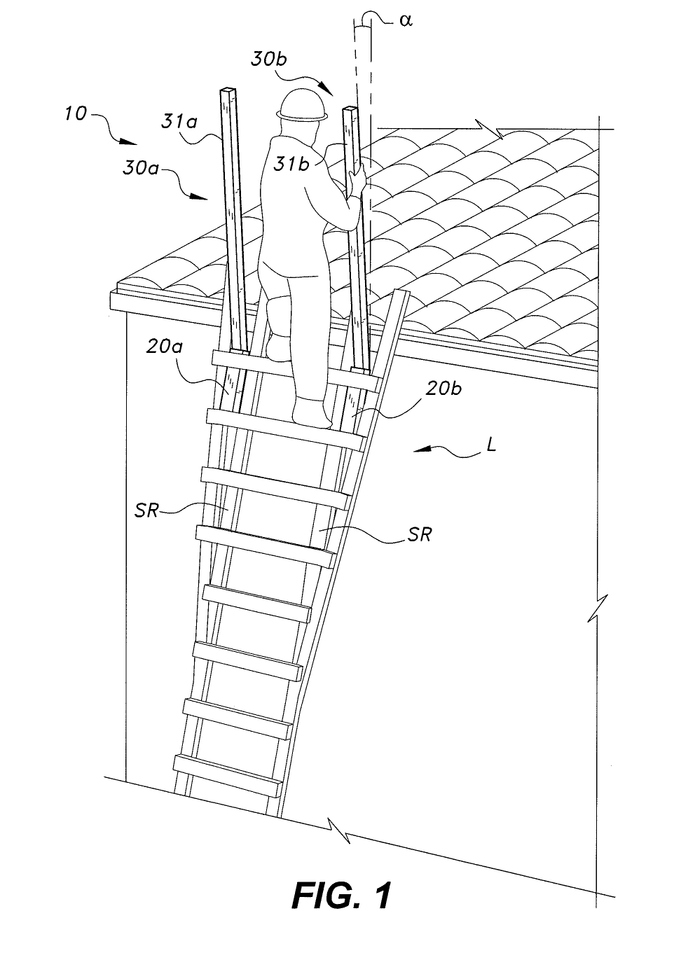

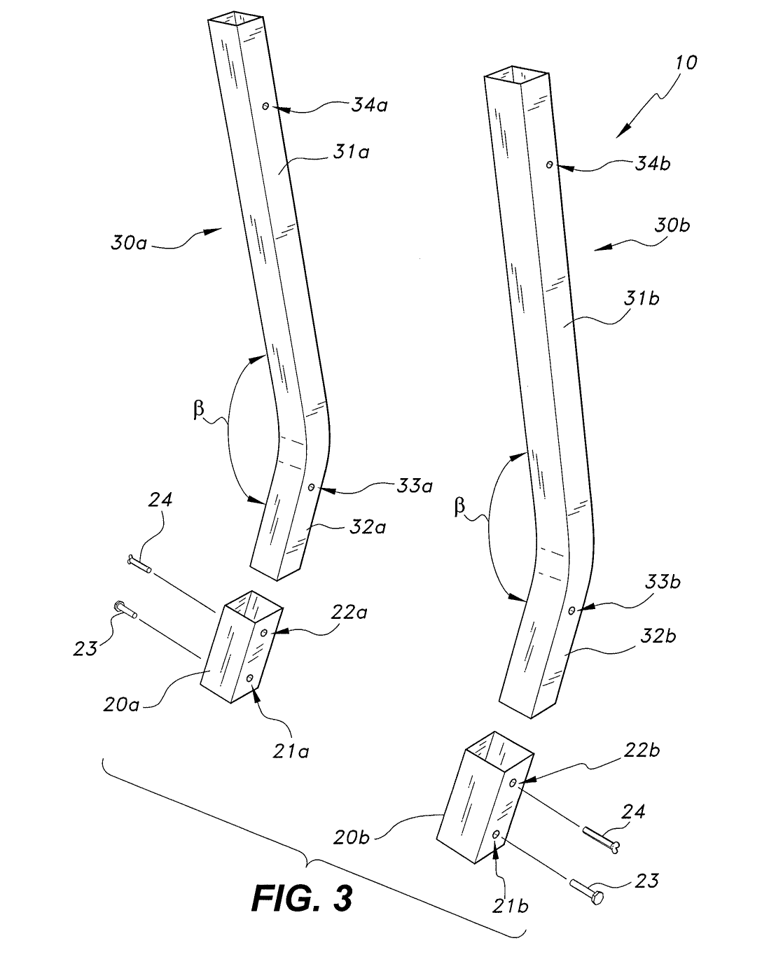

As best seen in FIGS. 1-3, a safety assembly 10 for ladders includes a pair of mounting brackets 20a, 20b and a pair of angled guide rails 30a, 30b, detachably connected to the mounting brackets 20a, 20b. The mounting brackets 20a, 20b can be connected to a ladder L, e.g., respective side rails SR of a ladder L. The angled guide rails can serve as handholds for a user positioned on the ladder L.

Mounting brackets 20a, 20b can be identical. Each mounting bracket 20a, 20b, is preferably a hollow beam or bar. The mounting brackets 20a, 20b can have a square, rectangular, or circular cross section. Each mounting bracket 20a, 20b has a hollow interior and an opening at one or both ends. The hollow interior of each mounting bracket 20a, 20b serves as a socket for selectively receiving a respective one of the guide rails 30a, 30b therein. Each mounting bracket 20a, 20b can be attached to the ladder L. For example, each mounting bracket 20a, 20b can be attached to a corresponding side rail SR of the ladder L near a top end of the ladder. The mounting brackets 20a, 20b can be permanently or detachably secured to the side rail SR in any suitable manner, e.g., welding, rivets, fasteners, or clamping assemblies.

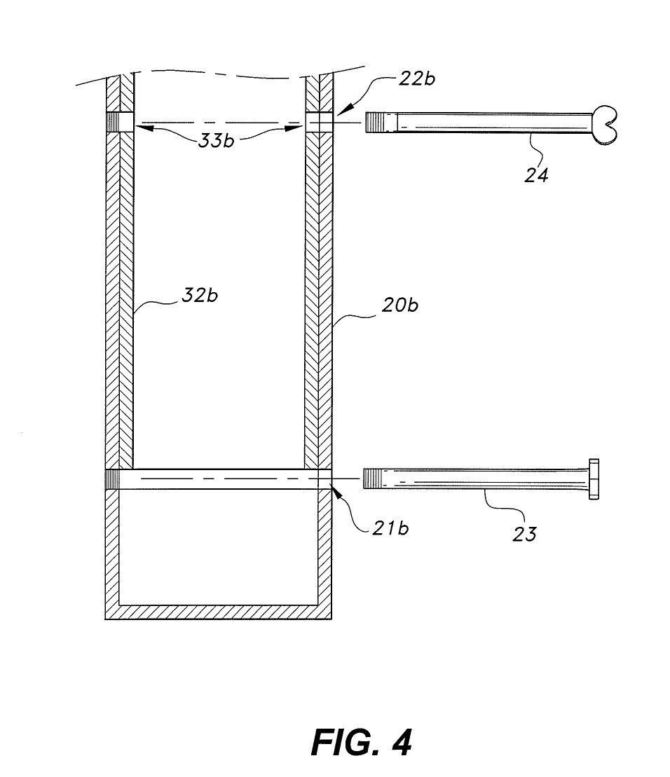

Stop abutment holes 21a, 21b extend through lower ends of mounting brackets 20a, 20b, respectively. Stop abutment holes 21a, 21b are configured to receive guide rail abutment fasteners for limiting insertion of the guide rails 30a, 30b into their respective mounting bracket 20a, 20b. Guide rail fixing holes 22a, 22b extend through upper ends of mounting brackets 20a, 20b, respectively. The guide rail fixing holes 22a, 22b are configured to receive guide rail securing fasteners for securing the guide rails 30a, 30b to the mounting brackets, 20a, 20b, respectively, as described in detail below. The stop abutment holes 21a, 21b and the guide rail fixing holes 22a, 22b can be threaded and/or unthreaded. For example, as shown in FIG. 4, a first wall of mounting bracket 20b through which the guide rail fixing hole 22b extends can be unthreaded and a second wall of mounting bracket 20b through which the guide rail fixing hole 22b extends can be threaded. Mounting bracket 20a can be similarly configured.

The mounting brackets 20a, 20b are preferably constructed from lightweight, sturdy materials, such as aluminum. However, other materials such as steel, carbon fiber, composites, sturdy plastics, and combinations thereof may also be used. The mounting brackets 20a, 20b can have any suitable size and/or dimension. For example, each mounting bracket 20a, 20b can be about 13 inches in length, about 1.75 inches in width, and about 1.25 inches in height. The walls of each mounting bracket 20a, 20b are preferably about 0.0625 inches to about 0.125 inches thick.

Guide rails 30a and 30b can be identical. Each guide rail 30a, 30b can be a hollow, angled beam or bar. The guide rails 30a, 30b can have a square, rectangular, or circular cross-section. The hollow beams can be lightweight to facilitate portability and installation while maintaining desired strength and rigidness of the component. At least a portion of the guide rails 30a, 30b can be configured to fit within the mounting brackets 20a, 20b. For example, the guide rails 30a, 30b can have a width of about 1.5 inches and a height of about 1.0 inch.

The guide rails 30a, 30b include first section 31a, 31b respectively, and second section 32a, 32b, respectively. The second sections 32a, 32b, include through-holes 33a, 33b, respectively. The first sections 31a, 31b, include through-holes 34a, 34b. First section 31a intersects with second section 32a, forming an angle β. Similarly, first section 31b intersects with second section 32b, forming an angle β. The angle β can range from about 155 degrees to about 168 degrees. The angle β can be about 167.5 degrees for example. Each second section 32a, 32b can have a length that is less than a length of the first section 31a, 31b and greater than a length of the mounting brackets 20a, 20b. A preferred length of the second section 32a, 32b is about 14 inches to about 16 inches. A preferred length for the first section 31a, 31b is at least 3 feet, e.g., about 3 feet to about 4 feet.

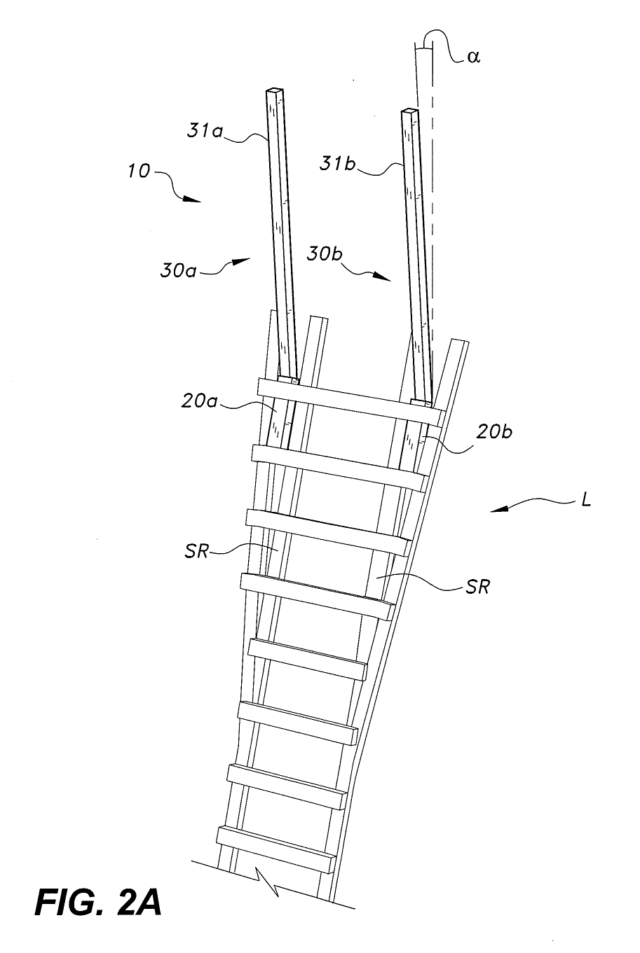

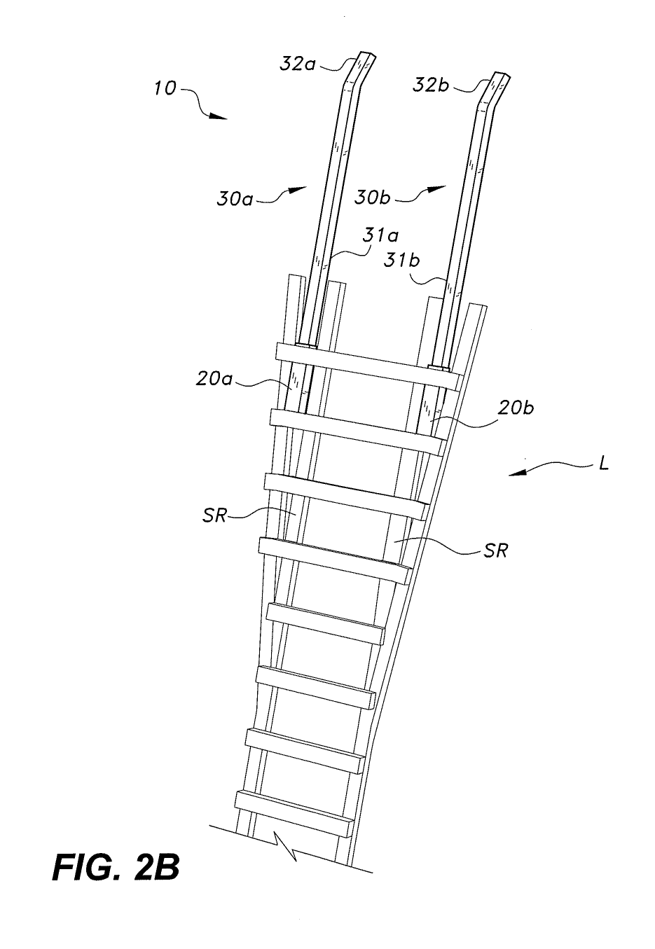

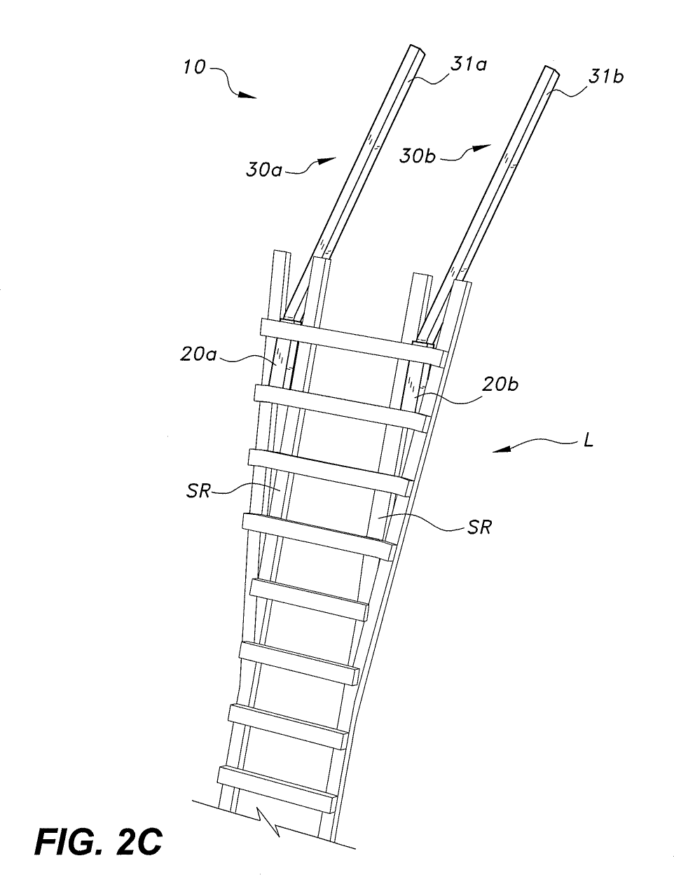

As shown in FIG. 2A, each second section 32a, 32b can be inserted into a respective one of the mounting brackets 20a, 20b such that through-holes 33a, 33b align with the guide rail fixing holes 22a, 22b, respectively. As shown in FIG. 4, guide rail fixing fasteners 24 can be inserted into the guide rail fixing holes 22a, 22b and through-holes 33a, 33b to secure the guide rails 30a and 30b to the mounting brackets 20a, 20b, respectively. In this configuration, the first section 31a, 31b of guide rails 30a, 30b are angled toward the front of the ladder, i.e., angled slightly toward the user. For example, when the ladder L is positioned against the structure such that the base of the ladder L has an angle of about 75° from the horizontal, e.g. a ground or floor surface, the first sections 31a, 31b can extend at an angle (angle α) that is about 15° from the vertical, e.g., the longitudinal axis of the structure against which the ladder rests. The tilt or angle of the first section 31 allows the user to easily grasp the guide rails 30a, 30b to maintain stability, without having to lean forward. This configuration also provides clearance for gutters and/or other trim.

Alternatively, each of the first sections 31a, 31b can be inserted into a respective one of the mounting brackets 20a, 20b such that through-holes 34a, 34b align with the guide rail fixing holes 22a, 22b, respectively. In this configuration, the first sections 31a, 31b are substantially aligned with the side rails SR and the second sections 32a and 32b extend in a direction away from the user (FIG. 2B). Although not shown, guide rail fixing fasteners 24 can be inserted into the guide rail fixing holes 22a, 22b and through-holes 34a, 34b to secure the guide rails 30a and 30b to the mounting brackets 20a, 20b, respectively.

Guide rail fixing fastener 24 can include an elongate bolt with a threaded distal end, for example. Stop fasteners 23 can be inserted into the stop abutment holes 21a, 21b to serve as a support for a bottom end of the guide rails 30a, 30b when positioned inside the mounting brackets 20a, 20b. Alternatively, the mounting brackets 20a, 20b may be closed at the bottom end forming a floor, and the bottom of the of the guide rails 30a, 30b may simply rest on this floor when assembled. The stop abutment fastener 23 and the guide rail fixing fastener 24 may be the same or different type of bolt or fastener. For example, the stop fastener 23 may be a typical hex head bolt requiring a corresponding tool or wrench for installation. The guide rail fixing fastener 24, on the other hand, may include a butterfly head to facilitate tool-less threading and unthreading of the guide rail fixing fastener 24. Alternatively, lock pins or spring loaded push-buttons may be used as fasteners to retain the guide rails.

FIG. 2C depicts yet another configuration of the safety assembly in which the first sections 31a and 31b of guide rails 30a and 30b extend toward the roof of the structure and away from the user. Each second section 32a, 32b is inserted into a respective one of the mounting brackets 20a, 20b such that through-holes 33a, 33b align with the guide rail fixing holes 22a, 22b, respectively. As shown in FIG. 4, guide rail fixing fasteners 24 can be inserted into the guide rail fixing holes 22a, 22b and through-holes 33a, 33b to secure the guide rails 30a and 30b to the mounting brackets 20a, 20b, respectively. When the ladder L is positioned against the structure such that the base of the ladder L has an angle of about 75° from the horizontal, e.g. a ground or floor surface, the first sections 31a, 31b can extend over the roof of the structure against which the ladder rests and away from the user. The tilt or angle of the first sections 31a and 31b allows the user to easily grasp the guide rails 30a, 30b to maintain stability, when it is desired to lean forward, such as stepping onto low-pitch or flat roofs. This configuration also provides clearance for gutters and/or other trim, as long as the ladder height is adjusted to avoid interference with the first sections 31a and 31b.

Although the safety assembly 10 has been described primarily for assisting a user to step onto or off of a roof top, other uses of the safety assembly 10 are also contemplated. For example, the safety assembly 10 can be useful to provide stability to a user who is situated two or three rungs from the top of the ladder for performing maintenance work on the structure, e.g., painting the structure or scraping paint from the structure.

The safety assembly 10 may be pre-installed on a ladder or provided as a kit with necessary hardware for installation on existing ladders. Though hollow beams are preferred, the guide rails 30a, 30b may also be constructed from solid beams of smaller dimensions and density to meet a desired weight limit. Moreover, the first sections 31a, 31b may be provided with a layer of grip enhancing material to provide users with a secure grip.

It is to be understood that the present invention is not limited to the embodiments described above, but encompasses any and all embodiments within the scope of the following claims.

I claim:

1. A safety assembly for ladders, comprising:
a pair of angled guide rails, each guide rail having a first section and a second section connected to the first section, the first and second sections being joined at an angle ranging from about 155 degrees to about 168 degrees, the second section having a length less than a length of the first section; and
a pair of hollow mounting brackets, each hollow mounting bracket configured to receive an end of a respective angled guide rail.

2. The safety assembly for ladders according to claim 1, wherein the angle is about 167.5 degrees.

3. The safety assembly for ladders according to claim 1, further comprising a pair of guide rail fixing fasteners for securing each mounting bracket to a respective guide rail.

4. The safety assembly for ladders according to claim 3, wherein:
each mounting bracket includes first and second parallel, opposing sidewalls, and third and fourth parallel, opposing sidewalls extending between and connected to the first and second sidewalls, the first sidewall including a first guide rail fixing hole, and the second sidewall including a second guide rail fixing hole aligned with the first guide rail fixing hole;
each guide rail first section includes first and second parallel, opposing sidewalls, and third and fourth parallel, opposing sidewalls extending between and connected to the first and second sidewalls, the first sidewall of each first section including a through-hole, and the second sidewall of each first section including a through-hole aligned with the through-hole of the first sidewall; and
each guide rail second section includes first and second parallel, opposing sidewalls, and third and fourth parallel, opposing sidewalls extending between and connected to the first and second sidewalls, the first sidewall of each second section including a through-hole, and the second sidewall of each second section including a through-hole aligned with the through-hole of the first sidewall.

5. The safety assembly for ladders according to claim 4, wherein each guide rail fixing fastener comprises a bolt.

6. The safety assembly for ladders according to claim 5, wherein each bolt has a threaded end and the second guide rail fixing hole of each mounting bracket is threaded for engaging the threaded end of a respective bolt.

7. The safety assembly for ladders according to claim 4, further comprising a pair of stop abutment fasteners, wherein the first sidewall of each mounting bracket further includes a first stop abutment hole and the second sidewall of each mounting bracket further includes a second stop abutment hole, the first and second stop abutment holes configured for receiving a respective stop abutment fastener.

8. The safety assembly for ladders according to claim 7, wherein the second stop abutment hole of each mounting bracket is threaded.

9. The safety assembly for ladders according to claim 4, wherein each mounting bracket has a closed bottom end.

10. The safety assembly for ladders according to claim 4, wherein each mounting bracket has an open bottom end.

11. A safety assembly for ladders, comprising:
a pair of angled guide rails, each guide rail having a first section and a second section connected to the first section, the first and second sections being joined at an angle ranging from about 155 degrees to about 168 degrees, the second section having a length less than a length of the first section;
a pair of hollow mounting brackets, each hollow mounting bracket configured to receive an end of a respective angled guide rail; and
a pair of guide rail fixing fasteners for securing each mounting bracket to a respective guide rail.

12. The safety assembly for ladders according to claim 11, wherein:
each mounting bracket includes first and second parallel, opposing sidewalls, and third and fourth parallel, opposing sidewalls extending between and connected to the first and second sidewalls, the first sidewall including a first guide rail fixing hole, and the second sidewall including a second guide rail fixing hole aligned with the first guide rail fixing hole;
each guide rail first section includes first and second parallel, opposing sidewalls, and third and fourth parallel, opposing sidewalls extending between and connected to the first and second sidewalls, the first sidewall of each first section including a through-hole, and the second sidewall of each first section including a through-hole aligned with the through-hole of the first sidewall; and
each guide rail second section includes first and second parallel, opposing sidewalls, and third and fourth parallel, opposing sidewalls extending between and connected to the first and second sidewalls, the first sidewall of each second section including a through-hole, and the second sidewall of each second section including a through-hole aligned with the through-hole of the first sidewall.

13. The safety assembly for ladders according to claim 12, wherein each guide rail fixing fastener comprises a bolt.

14. The safety assembly for ladders according to claim 13, wherein each bolt has a threaded end and the second guide rail fixing hole of each mounting bracket is threaded for engaging the threaded end of a respective bolt.

15. The safety assembly for ladders according to claim 12, further comprising a pair of stop abutment fasteners, wherein the first sidewall of each mounting bracket further includes a first stop abutment hole and the second sidewall of each mounting bracket further includes a second stop abutment hole, the first and second stop abutment holes configured for receiving a respective stop abutment fastener.

16. The safety assembly for ladders according to claim 15, wherein the second stop abutment hole of each mounting bracket is threaded.

17. The safety assembly for ladders according to claim 12, wherein each mounting bracket has a closed bottom end.

18. The safety assembly for ladders according to claim 12, wherein each mounting bracket has an open bottom end.
